(19) United States
(12) Patent Application Publication
(10) Pub. No.: US 2015/0339791 A1
(43) Pub. Date: Nov. 26, 2015

(54) METHOD AND SYSTEM FOR MONITORING CONGESTIVE HEART FAILURE RISK OF A CARDIAC PATIENT

(71) Applicant: Nikias Group, LLC, Bethesda, MD (US)

(72) Inventor: Hassan Tetteh, Bethesda, MD (US)

(21) Appl. No.: 14/717,329

(22) Filed: May 20, 2015

Related U.S. Application Data
(60) Provisional application No. 62/001,051, filed on May 20, 2014.

(51) Int. Cl. G06Q 50/22; G08B 25/01; G06F 19/00; G06Q 10/10

(52) U.S. Cl. CPC G06Q 50/22; G06Q 10/10; G08B 25/016; G06F 19/3418; G06F 19/3431; G06F 19/345

(57) ABSTRACT

A method for monitoring a patient after release from a health care facility includes: monitoring, using a control module, at least one characteristic of the patient in an outpatient setting; based on the one or more characteristics, determining a risk of readmission; and when the risk of readmission is above a certain threshold, automatically generating a notification to a healthcare provider to provide intervention. A system for monitoring the patient includes: a sensor configured to measure at least one characteristic of the patient in an outpatient setting; and a control module in communication with the sensor, the control module configured to: monitor the at least one characteristic via the at least one sensor; based on the one or more characteristics, determine a risk of readmission; and when the risk of readmission is above a certain threshold, automatically generate a notification to a healthcare provider to provide intervention.

### CROSS-REFERENCE TO RELATED APPLICATION

This application claims the benefit of priority of U.S. provisional patent application No. 62/001,051, titled “METHOD AND SYSTEM FOR MONITORING CONGESTIVE HEART FAILURE RISK OF A CARDIAC PATIENT,” filed on May 20, 2014, which is incorporated herein in its entirety by this reference.

### TECHNICAL FIELD

The present invention is directed towards a method and system for monitoring a congestive heart failure risk of a cardiac patient, and, more particularly, towards a method and system for monitoring a congestive heart failure risk of a cardiac patient that has been discharged from a healthcare treatment facility after a cardiac treatment.

### BACKGROUND

Five million Americans have congestive heart failure, (CHF) and over 600,000 patients are newly diagnosed each year. Many patients that are hospitalized and treated deteriorate upon discharge and are re-admitted because of inefficient outpatient clinical management, and preventable excessive weight gain.

The United States spends over $32 Billion annually to treat and care for over 5 million adults that suffer from congestive heart failure (CHF). Over 1 million Americans are hospitalized for related CHF illness each year, and of those approximately 27% are readmitted to the hospital within 30 days of discharge from the hospital, usually because of excessive fluid retention, consequent weight gain, and exacerbation of heart failure. It is estimated that 40% of the readmissions could be avoided if outpatient care was optimized through better care coordination. Patients and payers are increasingly holding health care providers and hospitals accountable for outcomes. In 2012, Medicare took the lead by financially penalizing health care facilities that have high readmission rates for CHF patients.

Readmissions are a significant problem for providers, hospital systems, and for patients and their families. The causes of readmission for CHF patients are multifactorial and usually share the common denominator of inefficient intervention and outpatient management of patients. Integrated practice units are one solution aimed at improving the experience of care and outpatient management of patients with chronic diseases. This type of initiative and others have been offered as solutions to address the problem of inefficient outpatient management and increased readmission of CHF patients. A fundamental common theme with most solutions offered to address the problem of CHF readmission includes an information technology platform. Improvement are needed to enable care providers to identify at risk CHF patients and allow for early outpatient intervention and ideally avoid preventable readmission events.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Disclosed herein is a method for monitoring a patient having a cardiac failure using a control module. The method in at least one embodiment includes monitoring one or more characteristics of the patient in an outpatient setting, based on the one or more characteristics, determining a risk of readmission, and when the risk of readmission is above a certain threshold, directing a healthcare provider to provide intervening treatment.

According to one or more embodiments, a method for monitoring a patient after admission and subsequent release of the patient from a health care facility includes: monitoring, using a control module, at least one characteristic of the patient in an outpatient setting; based on the one or more characteristics, determining a risk of readmission; and when the risk of readmission is above a certain threshold, automatically generating a notification to a healthcare provider to provide intervention.

In at least one example, the at least one characteristic includes the weight or Body Mass Index (BMI) of the patient.

In at least one example, the weight and BMI of the patient is determined by the patient self weighing on a scale that is in wireless communication with the control module.

In at least one example, the method further includes determining at least one static characteristic of the patient.

In at least one example, the at least one static characteristic of the patient includes at least one of height, sex, and ethnicity.

In at least one example, the method further includes determining at least one risk factor for a patient.

In at least one example, the at least one risk factor includes at least one of arrhythmia; tobacco use; connective tissue disease; diabetes; dilated cardiomyopathy; drug abuse; HIB cardiomyopathy; hypertension; ischaemic heart disease; muscle infiltration; obesity; obstructive sleep apnea; pharmaceutical drug use; valvular heart disease; and viral myrocarditis.

In at least one example, the at least one characteristic includes weight, and wherein the certain threshold includes a weight gain threshold.

In at least one example, the risk of readmission is determined with a moving ranges chart.

In at least one example, the method further includes determining a risk category associated with the patient.

According to one or more embodiments, a system for monitoring a patient after admission and subsequent release of the patient from a health care facility includes: at least one sensor device configured to measure at least one characteristic of the patient in an outpatient setting; and a control module in communication with the at least one sensor device, the control module configured to: monitor the at least one characteristic via the at least one sensor device; based on the one or more characteristics, determine a risk of readmission; and when the risk of readmission is above a certain threshold, automatically generate a notification to a healthcare provider to provide intervention.

In at least one example, the at least one characteristic includes the weight or Body Mass Index (BMI) of the patient.

In at least one example, the at least one sensor device includes a scale that is in wireless communication with the control module, and wherein the control module is configured to determine the weight and BMI of the patient when the patient self weighs on the scale.

In at least one example, the control module is configured to determine at least one static characteristic of the patient.

In at least one example, the at least one static characteristic of the patient includes at least one of height, sex, and ethnicity.

In at least one example, the control module is configured to determine at least one risk factor for a patient.

In at least one example, the at least one risk factor includes at least one of arrhythmia; tobacco use; connective tissue disease; diabetes; dilated cardiomyopathy; drug abuse; HIB cardiomyopathy; hypertension; ischaemic heart disease; muscle infiltration; obesity; obstructive sleep apnea; pharmaceutical drug use; valvular heart disease; and viral myrocarditis.

In at least one example, the at least one characteristic includes weight, and wherein the certain threshold includes a weight gain threshold.

In at least one example, the risk of readmission is determined with a moving ranges chart.

In at least one example, the control module is configured to determine a risk category associated with the patient.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a flowchart of a method, according to at least one embodiment, for treating a patient to reduce hospital readmission.

FIG. 2, which shows both a system and method, according to at least one embodiment, to collect a CHF patient's weight and provide notifications.

FIG. 3 represents a system or platform, according to at least one embodiment.

FIG. 4 shows a GUI screenshot as displayed for a web interface associated with the platform of FIG. 3 according to at least one embodiment.

FIG. 5 is a screenshot listing of ontology classes as created in Protégé for the purpose of executing SWRL rules according to at least one embodiment.

FIG. 6 shows a system according to at least one embodiment.

FIG. 7 is a graph showing weight measurements carried out over a one month period.

FIG. 8 is a graph of the weight measurements of FIG. 7, showing upper and lower natural process limits created by use of the data according to at least one embodiment.

FIG. 9 is a moving ranges chart that indicates a specific measurement that is considered out of control and/or prompting notification according to at least one embodiment.

FIG. 10 illustrates a classification system using RED, YELLOW and GREEN indicators in response to a measured or determined characteristic according to at least one embodiment.

FIG. 11 shows a system, according to at least one embodiment, by which the method of FIG. 12 is facilitated.

FIG. 12 is a flow chart of a method of monitoring one or more characteristics of a patient in an out-patient setting.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

These descriptions relate at least to a solution that facilitates outpatient CHF patient management according to at least one embodiment. The advent of wearable sensors and Wi-Fi enabled devices allows objective weight measurements to be collected remotely from CHF patients.

One or more general methods disclosed herein are configured for being carried out on a control module (platform) that is configured as a computing device. In at least one embodiment, a method for monitoring a patient having a cardiac failure using a control module includes: monitoring one or more characteristics of the patient in an outpatient setting; based on the one or more characteristics, determining a risk of readmission; and when the risk of readmission is above a certain threshold, notifying or directing a healthcare provider to provide intervening treatment.

The one or more methods disclosed herein use ontologies and a problem solving method (PSM) to calculate individual patient weight variation, and identify patients that may be at risk, based on probabilities, for developing symptoms that will cause readmission. Using the one or more methods disclosed herein, providers can remotely monitor CHF patients and intervene early clinically on patients that are “at risk” based on their weight variation.

The one or more methods disclosed herein constitute a solution that facilitates outpatient CHF patient management. The advent of wearable sensors and Wi-Fi enabled devices allows objective weight measurements to be collected remotely from CHF patients.

Increased specialization of medical care has created an opportunity to coordinate disparate care in the CHF patient population and use collected data to inform and implement a plan of care. Through an ontology utilizing approach, collected subjective and objective data of CHF patients is used to formally represent and denote the properties, hierarchy, and relationships of information to improve CHF outpatient management while reducing the need for inpatient hospitalization. Specifically, a problem solving method synthesizes collected data of CHF patients' daily weight variation and associated symptoms to identify weight gain, a known risk factor for CHF exacerbation and readmission, and triggers a notification to a provider. This provides an opportunity for the provider to preemptively assess the “at risk” patient and prescribe a course of care as an outpatient before the patient requires re-hospitalization or health care facility readmission for a preventable problem.

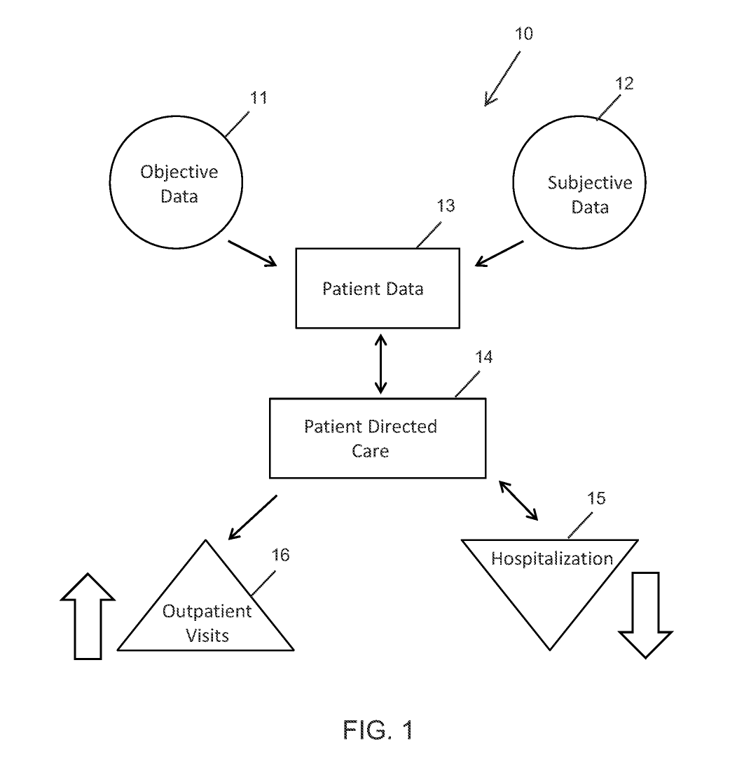

Methods—The application in at least one embodiment includes the building blocks for monitoring patients with congestive heart failure. A clinical model for the one or more methods and systems disclosed herein. FIG. 1 is a flowchart of a method 10, according to at least one embodiment, for treating a patient to reduce hospital readmission. The method 10 includes the collection of a CHF patient's objective data in step 11 and subjective data in step 12 to accumulate patient data in step 13. The data collected informs a clinical decision that results in an action. The action can taken on behalf of the patient or by the patient in step 14, as informed by the collected data, results in decreased hospital or health care facility readmission (step 15) and increased outpatient engagement (step 16) with the clinical provider team and patient. This process is illustrated succinctly in FIG. 1.

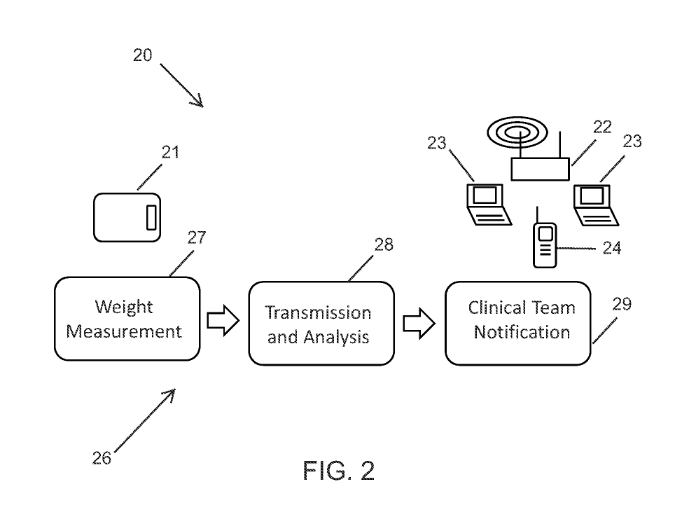

Specifically, an approach according to at least one embodiment to collect the CHF patient's weight, for example via a Wi-Fi enabled scale, is illustrated in FIG. 2, which shows both a system 20 and method 26 according to at least one embodiment. The scale 21 may also communicate with the control or communication module 22 in any other appropriate manner, such as, for example, by RF, Blue-Tooth®, and the like. The patient may self weigh himself or herself, meaning the patient conducts the weighing without a health care provider necessarily being present. The acquired patient measurements are captured (step 27) and variations in weight are calculated to determine (step 28) patients that may be at high risk for readmission based on excessive weight gain, which can exacerbate congestive heart failure symptoms. The captured data is focused on patient demographics, weight measurement, notification (step 29), and care. One or more computing systems 23 and mobile devices 24 in communication with the control or communication module 22 may be utilized in the data collection, calculations and determinations, and notifications and care. This clinical and process workflow is illustrated in FIG. 2. The sensor device 21 in communication with the control or communication module 22 is expressly described as a scale for measuring weight. Other types of sensor devices, which may be wearable, are within the scope of these descriptions, including but not limited to sensors configured to monitor one or more of heart rate, blood pressure, and patient temperature.

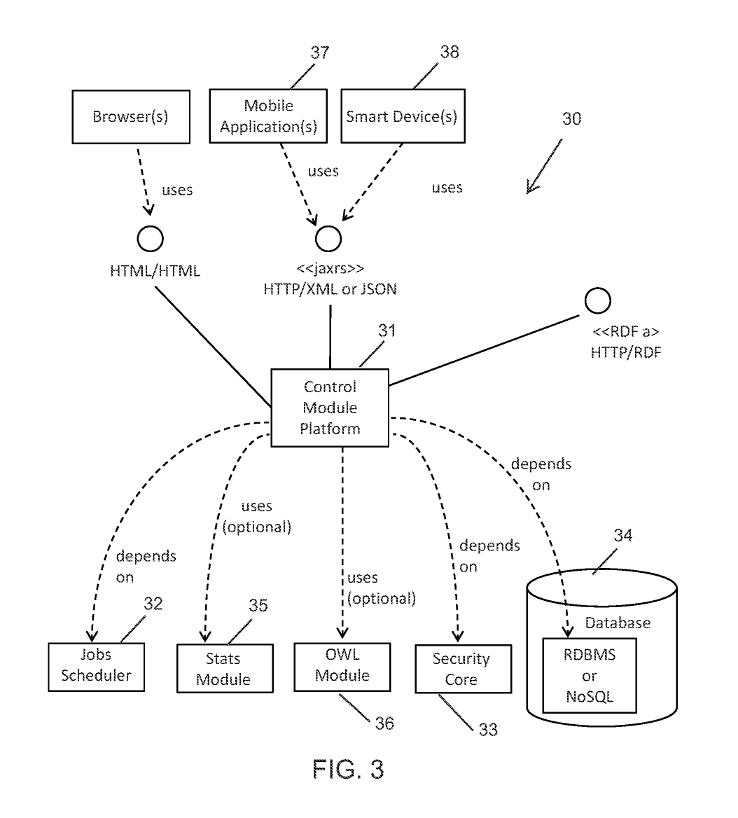

Platform Design—The system was designed from the outset to be a platform 30, with CHF identified as the first decision support/PSM module for this design iteration. FIG. 3 breaks out the components of the platform and a review of each component follows.

Platform—The platform control module 31 includes one or more computing devices and servers and is built using the Java-based Grails development framework. Grails provides a stack of tools (e.g., hibernate, bootstrap, HTML5, Spring) with a pluggable framework for deployment creating opportunity to use different databases, servlet containers, and Javascript resource libraries.

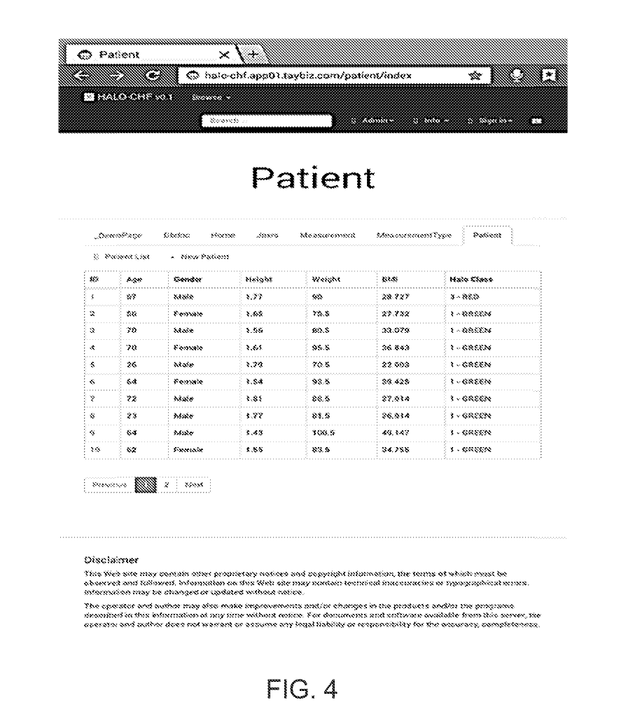

The platform was designed from the ground up to be deployed as a Software-as-a-Service (SaaS) offering. FIG. 4 shows a GUI screenshot as displayed for a web interface associated with the platform according to at least one embodiment.

Jobs Scheduler Module 32—Much of the domain class objects use event-driven mechanisms to keep internal details calculated. For instance, a Patient's BMI information is calculated when a new weight measurement is entered into the platform. However, more complicated business rules required a periodic jobs task to run based on the expectations of the users. In one or more embodiments, it is possible to run many different jobs at different frequencies. The jobs scheduler module may be in communication with the control module and additional modules associated with the system. As described herein, computer software program that is an interface that gets information from a wearable sensor and convey that information to the platform. The program is a tasker that takes in information and integrates them into the platform. Jobs scheduler is in communication with mobile and applications.

Security Core Module 33—The security core module maintains the User information including email information for notification. Modern security methods such as OAuth2 create a rich opportunity for a social mechanism where users could associate their Patient record with their Facebook® or Google account. This creates the concept of federated identity and almost removes the requirement that a single authoritative patient ID be maintained in the platform.

Database Module 34—The database selected for the one or more embodiments disclosed herein Java enabled. However, the platform may be configured for use with Big Data trending and analysis, or any other appropriate database.

Stats Module 35—The one or more embodiments disclosed herein may execute R script for regression analysis and statistical “heavy lifting” calculations. The one or more embodiments as designed include a port of the R engine in Java. The stats module is configured for storing characteristic data about a given patient. The stats module may take characteristics of the patient, including weight, BMI, food intake, temperature, blood pressure and these characteristics are stored and calculated on a patient.

OWL Module 36—Reading and processing OWL files outside of the Protégé editor is a powerful way to leverage an ontology and SWRL rules in a separate application. The OWL API is included in the platform with the intent of supporting both the RDF interface of the application and potentially using SWRL as a business rules mechanism.

Mobile Application(s) 37 and Smart Device(s) 38—The platform is designed services-first as an analytics platform using mobile applications on smart phones and tablets for content consumption, and some data entry. Conversely smart devices such as Fitbit®, Nike®, iHealth® are content creators, creating a stream of health-related information. The platform exposes a RESTful® API for creating measurements from smart devices and creative developer communities as well.

Ontology and Class Design—The one or more ontology decisions disclosed herein were innovated in view of the HEARTFAID project, which is a European research and development project focused on clinical management of heart failure diseases, and which may have used an “HF ontology.” An OWLAPI- or Protégé-readable version may be used, a custom ontology may be created, and/or a robust CHF ontology may be chosen for use.

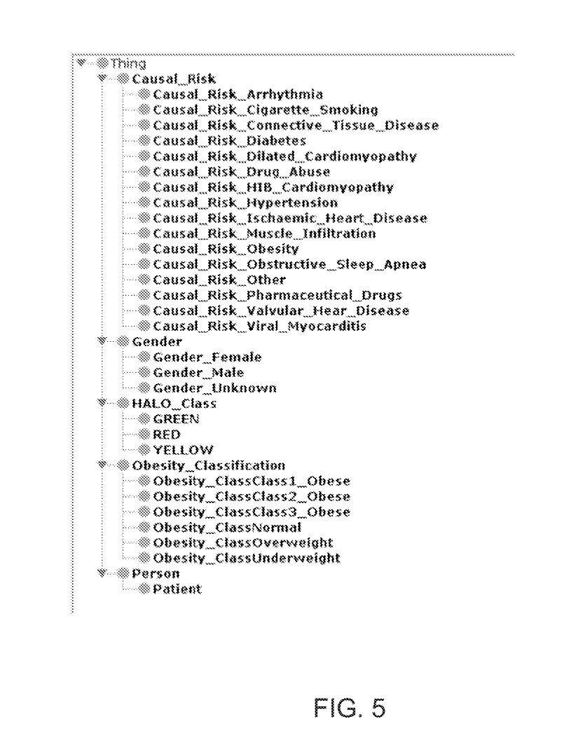

FIG. 5 is a screentshot listing of ontology classes as created in Protégé for the purpose of executing SWRL rules according to at least one embodiment.

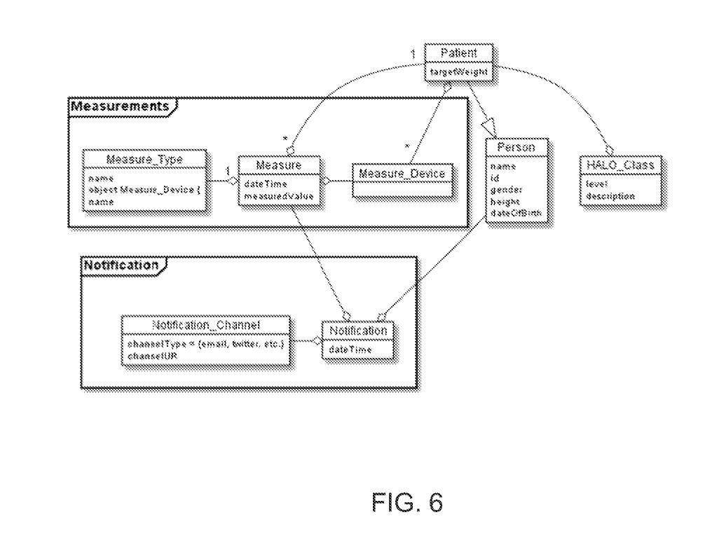

The Transmission and Analysis (shown in Table 1) PSM outputs are Class codes. These codes are used as the inputs to the notification PSMs. The platform is designed to use a very simple notification subsystem. Many notification engines exist and the platform uses the Class as the first input. FIG. 6 shows a system according to at least one embodiment.

Classes—The classes listed in Table 1 were designed and most implemented in the first sprint:

TABLE 1

| Class | Description/Notes |
|---|---|
| Measure_Type | Examples include Weight, PulseOx, and BMI. The |
| | platform PSMs currently work with Weight |
| | tracking. |
| Measure | An individual measurement taken in time for a Patient. |
| | e.g., Patient #1, 20140221, BMI, 30, % |
| Measure_Device | e.g., Paper, SmartPhone, MIT T-shirt, FitBit, Nike |
| | Fuel, etc. This table is not currently implemented |
| | but it's shown to answer the question as to |
| | “what” or “who” did the measuring. |
| Patient | In the platform the Patient record is the center of all |
| | Measures. |
| Associated risk | A type of warning used as a signal flag (RED, |
| category | YELLOW, GREEN) for clinicians and care |
| | providers to quickly assess the condition of a patient. |

Algorithms/PSMs—The one or more control modules disclosed herein may use one or more problem solving methods (PSMs).

Statistical Process Control (SPC)—The one or more PSMs disclosed herein are not gathered “horizontally” and reasoned outside of time, but instead are journaled “vertically” through time creating the opportunity to analyze sets of data using statistical methods.

A particular method for classifying problem conditions is Statistical Process Control.

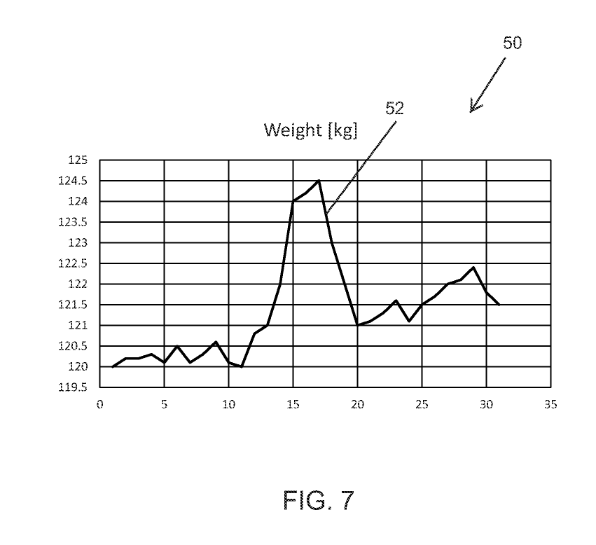

FIG. 7 is a graph 50 showing thirty one weight measurements 52 carried out over a one month period. Current systems create arbitrary limits, say 15% over, or 10% over 7 days, irrespective of the collected data and other factors that could be considered.

Advantageously, by using a statistical process method called the moving ranges charts and statistical process control, according to at least one embodiment within the scope of these descriptions, collected data is used to set limits and/or notification thresholds, and a practitioner can clearly see where measured system variable (the patient's weight here) is “out of control” and/or notification is automatically prompted, for example by exceeding the set thresholds.

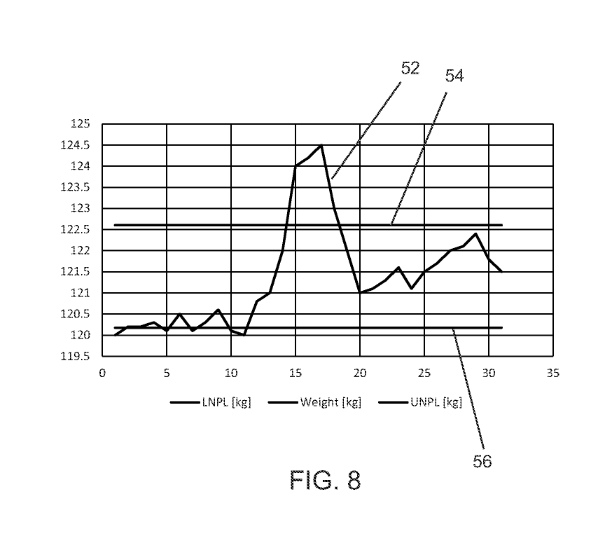

FIG. 8 is a graph of the weight measurements 52 of FIG. 7, showing upper 54 and lower 56 natural process limits created by use of the data according to at least one embodiment of a system and method according to these descriptions.

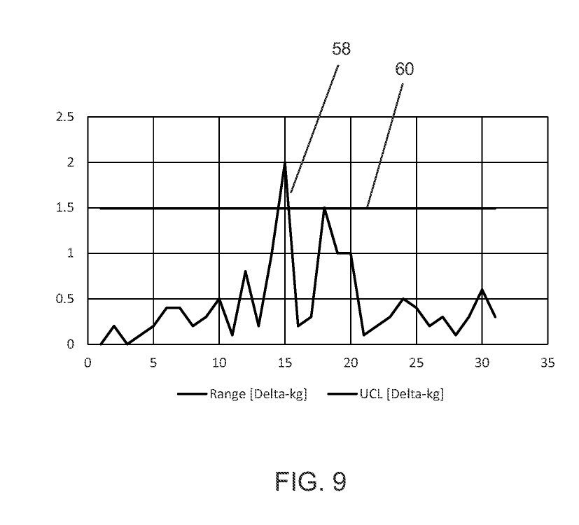

FIG. 9 below is a moving ranges chart that indicates a specific measurement 58 that is considered out of control and/or prompting notification according to at least one embodiment of a system and method according to these descriptions. Both the individual and ranges charts offer the clinician opportunities to create rules based on out of control conditions. For example in the chart below customarily a single out of bound point beyond a threshold 60 may be a warning condition, while two in a row indicates a more dire condition, and notification may be prompted in either or both cases. A particular method involves comparing, in this example, the weight gain/loss from one day compared to the weight gain/loss from the previous day. For example, if the weight gain in any given day is a certain amount, the weight gain associated with the next day is compared to that certain amount.

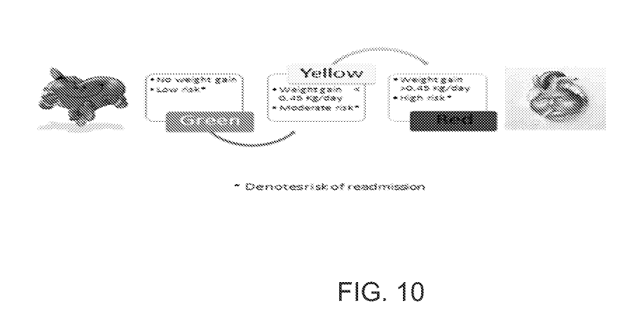

If-Then Rules, Drools, and Forward-Chaining Rete Tools—The one or more methods disclosed herein include associating a classification system of, for example, RED, YELLOW or GREEN in response to a measured or determined characteristic (FIG. 10). For example, if the moving ranges for two consecutive days are outside of a predetermined threshold, then the patient may be changed from a green classification to a yellow or red classification, depending on the instructions provided by a treatment provider.

Logistic Regression—Logistic Regression is proposed to determine the probability of a CHF patient at risk for being readmitted. A generic algorithm/function is built as a service that will accept different combinations of variables and output a model that could identify CHF patients at risk for readmission. Output would also include the coefficients of the regression and other useful data to evaluate the efficiency of the prediction.

Variables to be passed as input to the above classifier are determined based upon the rules set up on top of CHF Ontology. In the one or more methods disclosed herein, a rule is a hypothesis while the classifier verifies the hypothesis by determining the probability based on evidence (patient data). The idea is that the initial rule sets are based on the prior knowledge of the clinician subject matter expert SMEs. For example, a simple rule could be, increase in BMI and lack of exercise impacts readmission. The classifier, using real collected patient data, would then verify this rule.

Rules, in at least one embodiment are “learned” based on a random combination of variables input to the classifier and then encoded back to Ontology rules for future reuse. This is useful with increasing availability of large data sets of real patients and could be used to identify novel causes. Further work also includes building cohorts using the rules (learned and defined) to enhance the learning mechanism.

Model—Logistic regression is a useful technique to ascertain the probability of an event. It is used in at least one embodiment to predict the probability of a patient being readmitted given the predictor variable data without prior knowledge. Selection of predictor variables is an important consideration and usually involves extensive univariate, multivariate analysis to determine the suitability for inclusion in the learning model. Performance of the classification model is also dependent on the availability of real large data sets that could be used for training and fine-tuning for specificity and sensitivity.

At least one embodiment of a system and method includes the ability to predict the odds of a CHF patient being readmitted after undergoing treatment and getting discharged. In evidence based medicine, current best evidence is used with discretion in making decisions about the care of the individual patients. While there are several rules that can be set up to identify potential risk cases, any new patterns or discoveries that can be made based on the real world data will augment methodologies and further improve the outcomes.

In at least one example, patient data will be available from the EHR and recent sensor devices that capture real time health information about patients. Data captured from these different sources is then evaluated for a possible inclusion in the logistic regression model.

For the purpose of the project, the following variables are considered: Patient Age, Gender, NYHA class, Weight, Height, BMI and surgery history. Each of the variables are the predictor variables and clinically relevant. BMI is a derived variable that can be calculated from weight and height.

Experimental Results—In one or more experiments, an initial data set of twenty patients with values captured for all variables including notes from the physician was provided. Table 2, which relates to CHF Patients with baseline weight, displays this summarized information. The clinician's notes were particularly helpful in capturing the patient symptoms and pertinent information. Existing ontologies were identified. However, there is considerable work involved in text mining, matching against one of the standard Ontologies such as SNOMED-CT and then preparing the data against each patient.

TABLE 2
Initial Heart Failure Patients
Data Set

| Patient | | | Initial | Height | | Heart | NYHA |
|---|---|---|---|---|---|---|---|
| Number | Age | Sex | Weight (Kg) | (m) | BMI | Surgery | Class |
| 1 | 67 | M | 84 | 1.77 | 26.81 | | 2 |
| 2 | 56 | F | 75 | 1.65 | 27.55 | | 2 |
| 3 | 70 | M | 80 | 1.56 | 32.87 | | 2 |
| 4 | 70 | F | 95 | 1.61 | 36.65 | Yes | 2 |
| 5 | 26 | M | 70 | 1.79 | 21.85 | | 2 |
| 6 | 64 | F | 93 | 1.54 | 39.21 | Yes | 2 |
| 7 | 72 | M | 88 | 1.81 | 26.86 | | 2 |
| 8 | 23 | M | 81 | 1.77 | 25.85 | Yes | 2 |
| 9 | 64 | M | 100 | 1.43 | 48.90 | Yes | 2 |
| 10 | 62 | F | 83 | 1.55 | 34.55 | Yes | 2 |
| 11 | 53 | M | 78 | 1.8 | 24.07 | | 2 |
| 12 | 52 | M | 91 | 1.69 | 31.86 | Yes | 2 |
| 13 | 63 | F | 98 | 1.61 | 37.81 | | 2 |
| 14 | 71 | M | 85 | 1.75 | 27.76 | | 2 |
| 15 | 57 | F | 89 | 1.71 | 30.44 | Yes | 2 |
| 16 | 68 | M | 95 | 1.56 | 39.04 | | 2 |
| 17 | 54 | F | 90 | 1.68 | 31.89 | | 2 |
| 18 | 65 | M | 78 | 1.66 | 28.31 | Yes | 2 |
| 19 | 66 | M | 81 | 1.54 | 34.15 | | 2 |
| 20 | 74 | M | 72 | 1.79 | 22.47 | | 2 |

After the initial assessment of the one or more methods disclosed herein, it was determined that 20 observations was too low for a meaningful model to perform well, and thus a sample set of 100K patients utilizing the prior knowledge of possible range of values in case of continuous variables and randomly selecting values for categorical variables was generated. To complete the training data set, readmission information was needed for these fictitious patients. Given the lack of real world data, this has been mocked up based upon a simple rule that patients that are older than 65 years of age having BMI greater than 35 have a high probability of readmission and thus belong to the class of readmission. On the population of 100K patients, the training data produces about 15K patients as being readmitted. This outcome was fair and reasonable for the training purposes and correlates to actual real world observed clinical trends.

All the observations were used for training. This is assuming that a separate test data set will be evaluated for test classification error. The following is the model that was used to fit the model, code snippet is in R language:
m<-glm(readm-age+gender+height+weight+bmi+surgery,family=binomial(link=“logit”), data=chf_data)

This was not an ideal model because of the rule created between readmission and age/weight variables. This results in a warning message of perfect or quasi separation. For the purposes of this experiment, this warning was ignored for simplicity reasons and to avoid spending significant time on the nuances of problem solving method.

Considering the above model, the same data set was used to predict the outcome.
out<-predict(m.chf_data[,c(1,2,4,5,6,7)],type=“response”)

Optimizing for the sensitivity and specificity, the following threshold is used for the final classification:
out<-ifelse(out<0.5,0,1)

This model works with 5% classification error on the training data set. It is evident that the model over-fitted with the training data and a real world test data set would potentially yield significantly low performance or higher classification error. Further model evaluation could occur in a real hospital setting where the output of the model and the expert opinion is captured independently and fidelity measured. Results could then be compared to determine the efficiency and applicability of the model. Based on the discretion of the clinical expert and standard guidelines, risk mitigation plans can then be planned.

Further work in the PSM involves extending the model to variables beyond the demographic type; performing a detailed exploratory data analysis, consider missing values using techniques such as imputation and refining the model. Also, longitudinal analysis of the measures is omitted in this method. For example, how changes in the weight affect the probability of the readmission. When satisfactory results are obtained, the model could be wrapped as a web service and exposed to take the data as input and produce classifications as output to the calling clients. The work done on the model, though academic in nature, establishes the importance of the problem solving method in the specific use case selected.

Evaluation—Evaluation of the one or more methods and systems described herein were evaluated in three ways. First, the results obtained for each patient model was measured against established clinical indicators for hospital inpatient admission criteria and compared for concurrence.

Two heart failure cardiology specialists independently evaluated the platform and patient model results. Each physician provided positive summative feedback on the platform's performance, concurrence of data, and utility.

Evaluation of the model's performance in assessing CHF patients in the context of identifying their risk for hospital readmission is based on a logistic regression PSM that is informed by individual weight variation and other factors (FIG. 10).

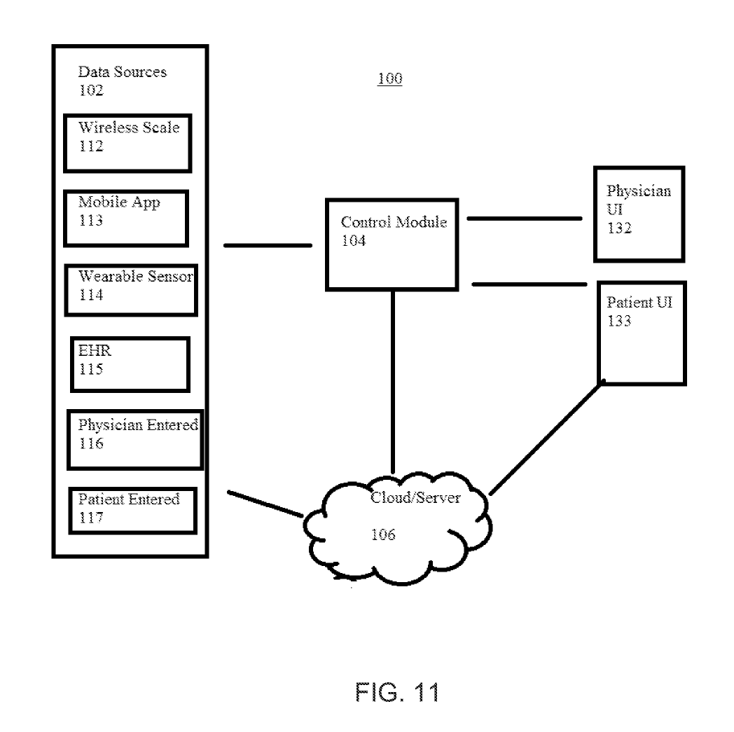

A system diagram is illustrated in FIG. 11 representative of the one or more embodiments disclosed herein.

The system 100 includes a variety of data sources 102, some of which have already been described herein. The data sources 102 may include a wireless scale 112, a mobile application 113, a wearable sensor 114, electronic health records 115, physician entered information 116, and patient entered information 117.

As one example, the wireless scale 112 may measure the weight of the patient and be equipped with other sensors to detect one or more additional characteristics such as BMI, temperature, etc, and also be configured to determine the time of measurement. The wireless scale 112 may be in communication via wireless communication such as Wi-Fi®, Blue-Tooth®, RF, and the like.

The mobile application 113 may be embodied on computer control code that is carried by a smart phone of a user. The mobile application 113 is configured to receive input from a user of one or more data points relevant to a medical condition. For example, the user may enter into the mobile application 113 medical related information such as heart rate, sleeping patterns, diet related information, weight, and the like. The mobile application 113 may then be further configured to transmit the medical related information to the control module 104 via the cloud 106 or an internet-based server.

Other wearable sensors 114 may be included and configured to monitor one of heart rate, blood pressure, patient temperature, etc. Wearable sensors 114 may also be in communication with control module 104 via cloud 106. In this manner, the wearable sensors may be configured to communicate via short-range communications to a central port which then transmits data to the cloud 106.

The data sources 102 may also include electronic health records (EHR). The EHR is provided to allow an additional data source for use by control module 104. The EHR may be useful for patient history and comparing data received from any other data source 102 with historical data associated with EHR. The EHR may be embodied on a module that is in communication with control module 104 through cloud 106.

The data sources 102 may also include other physician entered 116 and patient entered 117 data. This may be embodied in a computing module where the physician enters data for physician entered 116 or the patient enters data for patient entered data 117. Each of these sources may be in communication with the control module 104 through the cloud 106.

A physician user interface 132 may be provided for monitoring one or more characteristics received from either data sources 102 or as output from the control module 104. The physician may be able to override and order healthcare provider treatment to a patient, even when the control module 104 does not determine that intervening treatment is required by monitoring the data and output via user interface 132.

Similarly, a patient user interface 133 may be provided for providing a display of information output from control module 104 or from data sources 102. In this manner, the patient may be able to track one or more health related characteristics.

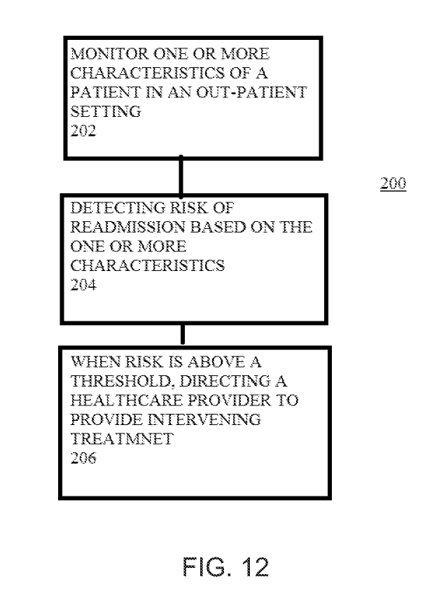

One or more methods 200 may also be provided herein as illustrated in FIG. 12.

The one or more methods 200 may be carried out on control module 104. The one or more methods 200 may include monitoring one or more characteristics of a patient in an out-patient setting 202. The one or more characteristics may include any of the data sources 102 described herein. The one or more methods 200 may further include determining a risk of readmission based on the one or more characteristics. The risk of readmission may be determined by control module 104 and may carry out any of the algorithms and PSMs disclosed herein. The one or more methods 200 may further include, when the determined risk is above a threshold criteria, directing a healthcare provider to provide intervening treatment or alerting the patient to seek medical assistance. This may be, for example, directing a healthcare provider to contact the patient to schedule an in-patient exam, contacting the patient to discuss treatment options to reduce their risk of readmission to a health care facility, or having the patient contact the healthcare provider in order to introduce a diet or exercise regime that will reduce the risk of readmission.

The various techniques described herein may be implemented with hardware or software or, where appropriate, with a combination of both. These techniques may be embodied on the server of the presently disclosed subject matter. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed invention. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed invention. When implemented on a general-purpose processor, the program code combines with the processor to provide a unique apparatus that operates to perform the processing of the presently disclosed invention.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for monitoring a patient after admission and subsequent release of the patient from a health care facility, the method comprising:
monitoring, using a control module, at least one characteristic of the patient in an outpatient setting;
based on the one or more characteristics, determining a risk of readmission; and
when the risk of readmission is above a certain threshold, automatically generating a notification to a healthcare provider to provide intervention.

2. The method of claim 1, wherein the at least one characteristic comprises the weight or Body Mass Index (BMI) of the patient.

3. The method of claim 2, wherein the weight and BMI of the patient is determined by the patient self weighing on a scale that is in wireless communication with the control module.

4. The method of claim 3, further comprising determining at least one static characteristic of the patient.

5. The method of claim 4, wherein the at least one static characteristic of the patient comprises at least one of height, sex, and ethnicity.

6. The method of claim 5, further determining at least one risk factor for a patient.

7. The method of claim 6, wherein the at least one risk factor includes at least one of arrhythmia; tobacco use; connective tissue disease; diabetes; dilated cardiomyopathy; drug abuse; HIB cardiomyopathy; hypertension; ischaemic heart disease; muscle infiltration; obesity; obstructive sleep apnea; pharmaceutical drug use; valvular heart disease; and viral myrocarditis.

8. The method of claim 1, wherein the at least one characteristic comprises weight, and wherein the certain threshold comprises a weight gain threshold.

9. The method of claim 1, wherein the risk of readmission is determined with a moving ranges chart.

10. The method of claim 1, further including determining a risk category associated with the patient.

11. A system for monitoring a patient after admission and subsequent release of the patient from a health care facility, the system comprising:
at least one sensor device configured to measure at least one characteristic of the patient in an outpatient setting; and
a control module in communication with the at least one sensor device, the control module configured to:
monitor the at least one characteristic via the at least one sensor device;
based on the one or more characteristics, determine a risk of readmission; and
when the risk of readmission is above a certain threshold, automatically generate a notification to a healthcare provider to provide intervention.

12. The system of claim 11, wherein the at least one characteristic comprises the weight or Body Mass Index (BMI) of the patient.

13. The system of claim 12, wherein the at least one sensor device comprises a scale that is in wireless communication with the control module, and wherein the control module is configured to determine the weight and BMI of the patient when the patient self weighs on the scale.

14. The system of claim 13, wherein the control module is configured to determine at least one static characteristic of the patient.

15. The system of claim 14, wherein the at least one static characteristic of the patient comprises at least one of height, sex, and ethnicity.

16. The system of claim 15, wherein the control module is configured to determine at least one risk factor for a patient.

17. The system of claim 16, wherein the at least one risk factor includes at least one of arrhythmia; tobacco use; connective tissue disease; diabetes; dilated cardiomyopathy; drug abuse; HIB cardiomyopathy; hypertension; ischaemic heart disease; muscle infiltration; obesity; obstructive sleep apnea; pharmaceutical drug use; valvular heart disease; and viral myrocarditis.

18. The system of claim 11, wherein the at least one characteristic comprises weight, and wherein the certain threshold comprises a weight gain threshold.

19. The system of claim 11, wherein the risk of readmission is determined with a moving ranges chart.

20. The system of claim 11, wherein the control module is configured to determine a risk category associated with the patient.
